(19) United States
(12) Patent Application Publication
(10) Pub. No.: US 2010/0308873 A1
(43) Pub. Date: Dec. 9, 2010

(54) SWITCHING DEVICE DRIVING APPARATUS

(75) Inventors: Kenji Kure, Oobu-shi (JP); Tsuneo Maebara, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/791,960

(22) Filed: Jun. 2, 2010

(30) Foreign Application Priority Data
Jun. 4, 2009 (JP) 2009-135048

(51) Int. Cl. G05F 3/16; B60L 1/00

(52) U.S. Cl. 327/109; 307/9.1

(57) ABSTRACT

An IGBT drive circuit is provided with a series regulator and a drive circuit. The series regulator includes a transistor and a control circuit. The control circuit and the drive circuit are integrated as an IC. The transistor is connected to the IC as an external component. Since the control circuit and the drive circuit are integrated, the number of components necessary for the IGBT drive circuit can be reduced. Further, the transistor is excluded from the IC so that radiant heat by the IC can be suppressed whereby an IC package having high heat-radiation characteristics is not necessarily used so that increasing size of the IC is avoided.

### CROSS REFERENCE TO RELATED APPLICATION

This application is based on and claims the benefit of priority from earlier Japanese Patent Application No. 2009-135048 filed on Jun. 4, 2009, the description of which is incorporated herein by reference.

### BACKGROUND OF THE INVENTION

1. Field of the Invention

The present invention relates to a switching device driving apparatus, and more particularly to an apparatus for driving a switching device used in a power circuit configuration.

2. Description of the Related Art

Conventionally, an apparatus for driving switching devices are known. Specifically, Japanese patent laid-open publication No. 2008-178200 discloses a power semiconductor switching circuit for driving IGBTs (Insulated Gate Bipolar Transistors) used for three-phase inverter circuits. The power semiconductor switching circuit includes a voltage regulator and a drive circuit. The voltage regulator is configured to output voltage used for driving the IGBTs, and includes a current controlled transistor and a control circuit which controls the operation of the regulator such as a comparator. The drive circuit is a circuit used for driving the IGBTs with a voltage supplied from the voltage regulator. The drive circuit includes MOSFETs (Metal Oxide Semiconductor Field Effect Transistors) connected in series with each other and is connected to the output end of the voltage regulator.

The above-described power semiconductor switching circuit frequently requires reducing the number of components used for the switching circuit itself. For this purpose, it is considered that the switching circuit may be configured as an integrated circuit (IC). However, the current controlled transistor consumes relatively large amount of current necessary for driving the IGBTs whereby amount of heat produced by the current controlled transistor becomes larger. Therefore, it is required to use an IC package having enough heat radiation characteristics that causes an increase of the IC size.

### SUMMARY OF THE INVENTION

In light of the above-described problem, an object of the present invention is to provide a switching device driving apparatus configured as an integrated circuit that reduces the number of circuit components and avoid increasing size of the integrated circuit.

To solve the problems mentioned above, the inventors of the present invention succeeded after several attempts to make an idea such that the control circuit and the drive circuit are integrated into the IC excluding a transistor circuit from the IC and arrange the transistor to be an external component of the IC. As a result, the amount of the circuit components can be reduced and also avoid increasing size of the integrated circuit.

To achieve the above-described object, a first aspect of the present invention provides an apparatus for driving a switching device, including a regulator for generating a regulated voltage at an output terminal, the regulated voltage being generated from an input voltage inputted from an input terminal, the regulator comprising: a transistor including three terminals of which one terminal is used as a control terminal to control an operation of the transistor and other two terminals are connected to the input terminal and the output terminal of the regulator respectively, and a control circuit for controlling the transistor via the control terminal to maintain the regulated voltage at the output terminal to be an predetermined voltage; and a drive circuit connected to the output terminal of the regulator, that drives the switching device to be driven by the voltage supplied via the output terminal, wherein the control circuit and the drive circuit are integrated into an integrated circuit, and the transistor is arranged outside the integrated circuit and electrically connected to the integrated circuit.

According to the first aspect of the present invention, the control circuit and the drive circuit are integrated as an IC. Therefore, the number of circuit components of the regulator can be reduced. In addition, since the transistor is configured as a component placed outside the regulator, an amount of heat produced by the IC is suppressed. Hence, it is not required to use an IC package having high heat-radiation characteristics so that increasing size of the IC is avoided. As described, the first aspect of the present invention has advantages such as reducing the number of circuit components and prevents the size of IC from increasing.

According to a second aspect of the present invention, the above-described apparatus is adapted to a power converting circuit used for converting DC voltage into AC voltage. In this configuration, the same advantages from the first aspect can be achieved.

As a third aspect of the present invention, in the apparatus, the power converting circuit is mounted on the vehicle. According to this configuration, the same advantages described above can be achieved.

### BRIEF DESCRIPTION OF THE DRAWINGS

In the accompanying drawings:

FIG. 1 is a circuit diagram showing a motor control apparatus according to an embodiment of the present invention;

FIG. 2 is a circuit diagram showing a power supply circuit used in the motor control apparatus; and

FIG. 3 is a circuit diagram showing an IGBT drive circuit.

### DETAILED DESCRIPTION OF PREFERRED EMBODIMENT

Hereinafter will be described embodiments of the present invention in detail. In this embodiment, a switching device driving apparatus is exemplified. Specifically, the switching device driving apparatus is mounted on a vehicle and is adapted to a motor control apparatus in which DC (direct current) power is converted to AC (alternative current) power and the converted AC power is applied to a three-phase AC motor.

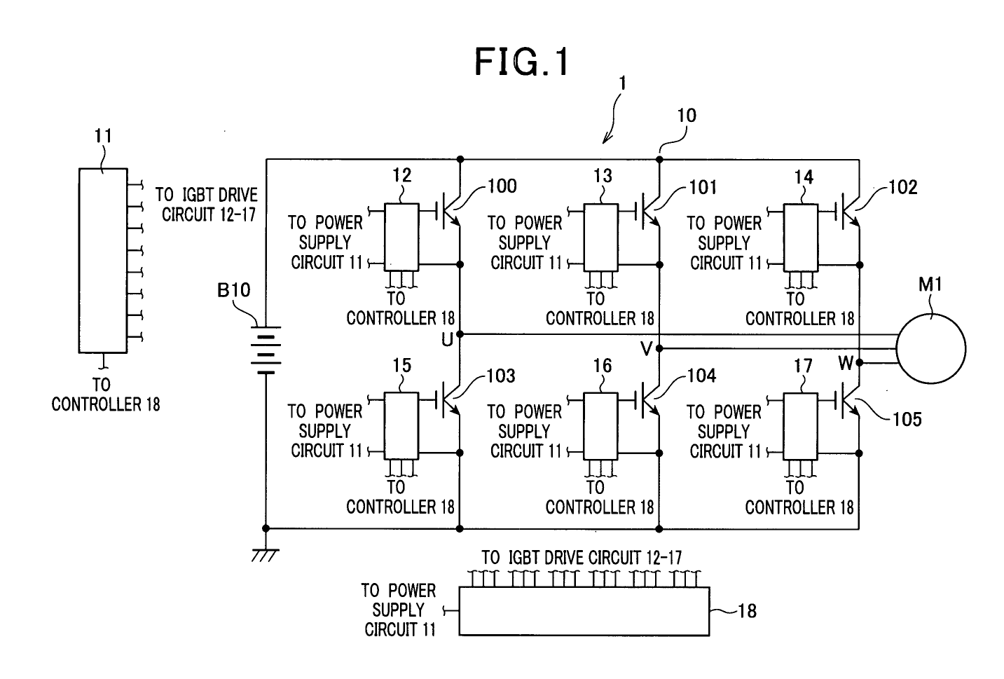

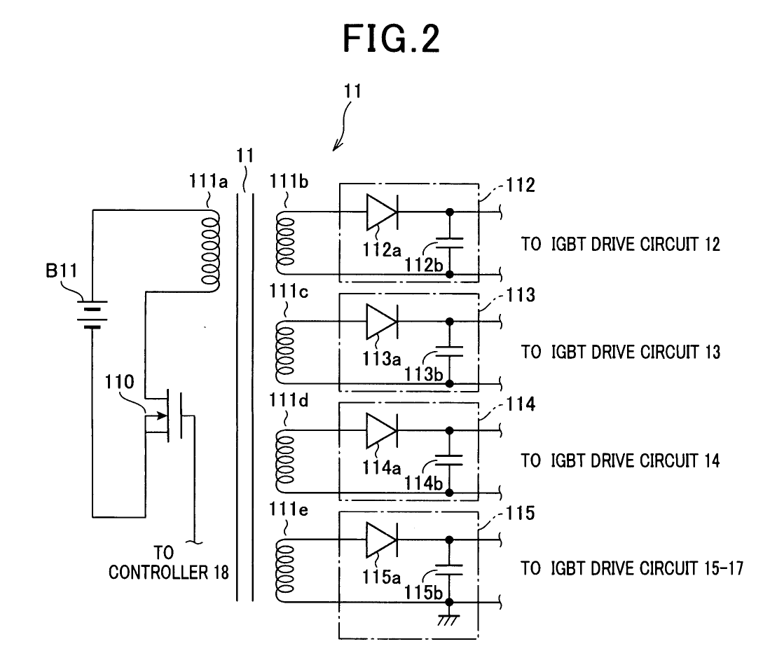

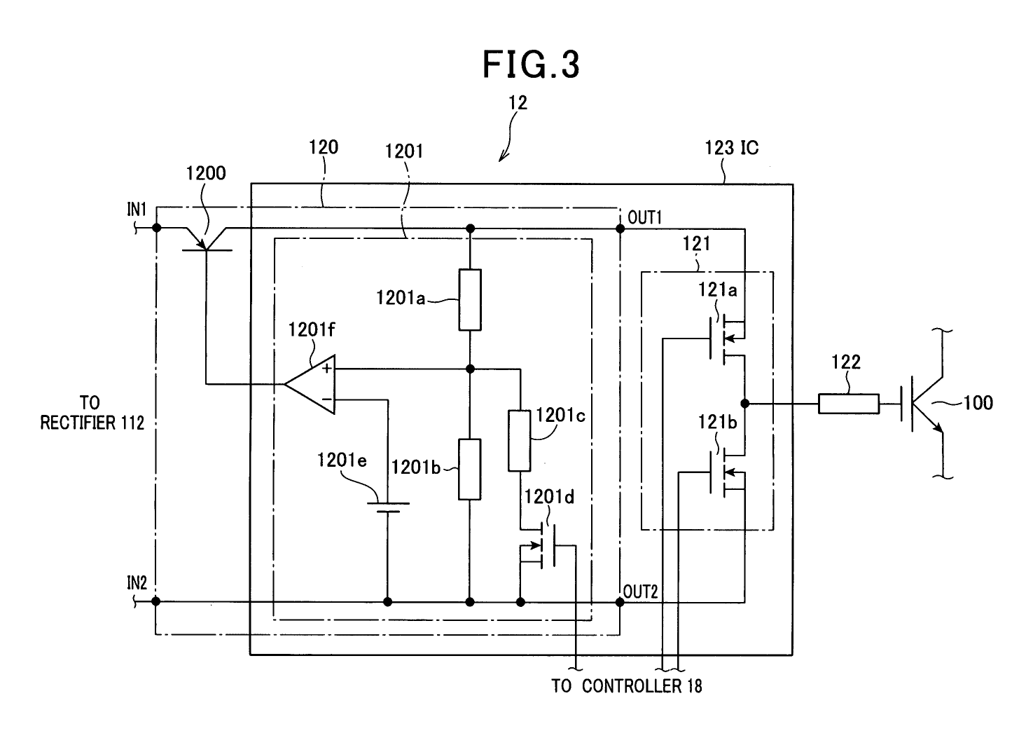

With reference to FIGS. 1 to 3, a configuration of the motor control apparatus as an embodiment of the present invention is described as follows. FIG. 1 is a circuit diagram showing a motor control apparatus according to the embodiment. FIG. 2 is a circuit diagram showing a power supply circuit and FIG. 3 is a circuit diagram showing an IGBT drive circuit.

As shown in FIG. 1, the motor control apparatus 1 is configured to convert DC voltage outputted from a battery B10 into three-phase AC voltage and supply a three-phase AC motor M1 with the AC voltage whereby the AC motor M1 can be driven. In other words, the motor control apparatus 1 drives the three-phase AC motor M1 by converting the DC power into the AC power. The motor control apparatus 1 includes a power converting circuit 10, a power supply circuit 11, IGBT drive circuits 12-17 (serving as a switching device driving apparatus), and a controller 18.

The power converting circuit 10 is a circuit used to convert the DC voltage of the battery B10 into the three-phase AC voltage and supply the three-phase AC motor M1 with the AC voltage. In other words, the power converting circuit 10 is a circuit used to convert the DC power into the AC power and supply the three-phase AC motor M1 with the AC power. The power converting circuit 10 includes IGBTs 100-105 (serving as a switching device).

The IGBTs 100-105 are controlled to be turned ON and OFF whereby the DC voltage is converted into the three-phase AC voltage.

The IGBTs 100-105 consists of three pair of IGBTs, i.e., IGBTs 100, 103, IGBTs 101, 104 and IGBTs 102, 105. Each pair of IGBT is connected in series each other. Specifically, each of the IGBTs 100-102 has an emitter terminal connected to each collector terminal of the IGBT 103-105 respectively. The three pairs of the IGBTs in which each pair is connected in series are connected in parallel with each other. The collector terminals of the IGBTs 100-102 are connected to the positive terminal of a battery B10. The emitter terminals of the IGBTs 103-105 are also connected to the negative terminal of the battery 810 and grounded. The gate terminals of the IGBTs 100-105 are connected to the IGBT drive circuits 12-17 respectively. Also, junction nodes U, V, and W at which respective pair of IGBTs (i.e., IGBTs 100, 103, IGBTs 101, 104 and IGBTs 102, 105) being connected in series, are connected to the three-phase motor M1 respectively.

The power supply circuit 11 operates based on a drive signal sent from the controller 18. The power supply circuit 11 converts the DC voltage of the battery B11 into voltage necessary for driving the IGBTs 100-105 and supplies the IGBT drive circuits 12-17. As shown in FIG. 2, the power supply circuit 11 has a MOSFET 110, a transformer 111 (111a-111e), and rectifiers 112-115.

The MOSFET 110 is configured to convert the DC voltage of the battery B11 to the AC voltage by turning ON and OFF. The transformer 111 is configured to convert the AC voltage which is converted by the MOSFET 110, into a predetermined AC voltage. The transformer 111 is provided with a primary coil 111a and secondary coils 111b-111e. Here, the secondary coils 111b-111d supply the IGBTs 100-102 with voltage necessary for driving the IGBTs, and the secondary coil 111e supplies the IGBTs 103-105 with the required voltage. One end of the primary coil 111a is connected to the positive terminal of the battery B11, and the other end is connected to the negative terminal of the battery B10 via the MOSFET 110. Also, both ends of the secondary coils 111b-111e are connected to the rectifiers 112-115 respectively.

The rectifiers 112-115 are configured to rectify the predetermined AC voltage outputted from the secondary coils 111b-111e to obtain DC voltage. The rectifier 112-115 includes diodes 112a-115a and capacitors 112b-115b. The anodes of the diodes 112a-114a are connected to one ends of the secondary coils 111b-111d respectively and the cathodes of the diodes 112a-114a are connected to the IGBT drive circuits 12-14 respectively. The other ends of the secondary coils 111b-111d are connected to the IGBT drive circuits 12-14 respectively. The capacitors 112b-114b are connected between the cathodes of the diodes 112a-114a and the other ends of the secondary coils 111b-111d. The other end of the secondary coil 111e is grounded and also connected to the IGBT drive circuits 15-17 respectively. The capacitor 115b is connected between the cathode of the diode 115a and the other end of the secondary coil 111e.

As shown in FIG. 1, the IGBT drive circuits 12-17 are configured to drive the IGBT 100-105 based on the drive signal sent from the controller 18. Since the IGBT drive circuits 12-17 are identical in the configuration to each other, the IGBT drive circuit 12 is representatively described as follow. As shown in FIG. 3, the IGBT drive circuit 12 includes a series regulator 120 (a linear type regulator for regulating power supply voltage), a driving circuit 121 and a resistor 122.

The series regulator circuit 120 is designed to regulate the DC voltage, converted by the rectifier 112, at a predetermined DC voltage necessary for driving the IGBTs 100-105 and supplies the regulated DC voltage to the driving circuit 121. The series regulator 120 includes a transistor 1200 and a control circuit 1201.

The transistor 1200 is configured to regulate the output voltage of the rectifier 112 at the predetermined DC voltage and outputs the regulated voltage. The emitter terminal of the transistor 1200 is connected to the rectifier 112 via the input terminal IN1 of the series regulator 120. As shown in FIG. 3, the collector terminal of the transistor 1200 is connected to the driving circuit 121 via the output terminal OUT1 of the series regulator 120. Also, the base terminal of the transistor 1200 is connected to the control circuit 1201.

The control circuit 1201 is configured to control the transistor 1200 so that the output voltage of the series regulator 120 is kept at the predetermined DC voltage. The control circuit 1201 includes a voltage divider consisting of resistors 1201a and 1201b, an adjustment resistor 1201c, a MOSFET 1201d, a voltage reference 1201e and an op-amp (operational amplifier) 1201f.

The voltage divider (i.e., resistors 1201a and 1201b) is used to to divide the output voltage of the series regulator 120 and outputs the divided voltage as a detected voltage. The voltage dividers 1201a and 1201b are connected in series. One end of the voltage dividers 1201a and 1201b which are connected in series is connected to the output terminal OUT1. Also, the other end of the voltage dividers 1201a and 1201b is connected to the rectifier 112 via the input terminal IN2 of the series regulator 120. Specifically, the other end of the voltage dividers 1201a and 1201b is connected to the other end of the capacitor 112b (as shown in FIG. 2) and connected to the driving circuit 121 via the output terminal OUT2 of the series regulator 120.

As shown in FIG. 3, the adjustment resistor 1201c and the MOSFET 1201d are used for changing a dividing voltage ratio of the voltage dividers 1201a and 1201b based on a switching command sent from the controller 18, when the output voltage of the series regulator 120 is detected. The adjustment resistor 1201c and the MOSFET 1201d are connected in series. Specifically, one end of the adjustment resistor 1201c is connected to the drain terminal of the MOSFET 1201d. The other end of the adjustment resistor 1201c is connected to a junction node at which the voltage dividers 1201a and 1201b are connected in series. The source terminal of the MOSFET 1201d is connected to the other end of the capacitor 112b via the input terminal IN2 and the driving circuit 121 via the output terminal OUT2.

The voltage reference 1201e is configured to output the reference voltage as a target voltage corresponding to the predetermined DC voltage. The positive-polarity end of the voltage reference 1201e is connected to the op-amp 1201f. The negative-polarity end of the voltage reference 1201e is connected to the other end of the capacitor 112b via the input terminal IN2 and the driving circuit 121 via the output terminal OUT2.

The op-amp 1201f compares the detected voltage with the reference voltage and drives the transistor 1200 based on the comparison result. The non-inverting input terminal of the op-amp 1201f is connected to the junction node at which the voltage dividers 1201a and 1201b are connected in series. Also, the inverting input terminal of the op-amp 1201f is connected to the positive end of the voltage reference 1201e. Further, the output terminal of the op-amp 1201f is connected to the base terminal of the transistor 1200.

The driving circuit 121 drives the IGBT 100 based on the drive signal sent from the controller 18. The resistor 122 is used to limit current flowing into the IGBT 100. The driving circuit 121 is configured to control the gate voltage of the IGBT 100 with the voltage supplied from the series regulator 120, whereby the IGBT 100 is turned on/off. The driving circuit 121 includes MOSFETs 121a and 121b, These MOSFETs 121a and 121b are connected in series. Specifically, the drain terminal of the MOSFET 121a is connected to the drain terminal of the MOSFET 121b. The source terminal of the MOSFET 121a is connected to the collector terminal of the transistor 1200 via the output terminal OUT1 of the series regulator 120. The source terminal of the MOSFET 121b is connected to the other end of the capacitor 112b via the output terminal OUT2 and the input terminal IN2 of the series regulator 120. Also, a junction node to connect the series-connected MOSFETs 121a and 121b is connected to the gate terminal of the IGBT 100 via the resistor 122.

The control circuit 1201 and the driving circuit 121 are integrated as a single integrated circuit, IC 123, The transistor 1200 is arranged outside the IC 123 to be electrically connected to the IC 123.

As shown in FIG. 1, the controller 18 controls the power supply circuit 11 and controls the power converting circuit 10 by using the IGBT drive circuits 12-17. The controller 18 is configured to output the drive signal and the switching command based on a command from an external device. The drive signal and the switching command are outputted to the power supply circuit 11 and the IGBT drive circuits 12-17. The controller 18 is connected to the power supply circuit 11. Specifically, the controller 18 is connected to the gate terminal of the MOSFET 110 as shown in FIG. 2. Further, as shown in FIG. 1, the controller 18 is connected to each of the IGBT drive circuits 12 to 17. Specifically, the controller 18 is connected to the gate terminals of the MOSFET 1201d, 121a and 121b as shown in FIG. 3. Similarly, the controller 18 is connected to the IGBT drive circuits 13-17 as well.

Next, with reference to FIGS. 1 to 3, hereinafter will be described the operation of the motor control apparatus. As shown in FIG. 1, the controller 18 outputs the drive signal to the power supply circuit 11. As shown in FIG. 2, the MOSFET 110 is turned on and off in response to the drive signal so that the DC voltage of the battery B11 is converted to the AC voltage. The converted AC voltage is adjusted to a predetermined AC voltage range by the transformer 111. Further, the adjusted AC voltage is converted to DC voltage by the rectifiers 112-115 and the converted DC voltage is supplied to the IGBT drive circuits 12-17.

As shown in FIG. 3, the op-amp 1201f included in the IGBT drive circuit 1201 compares the detected voltage which is detected by the voltage dividers 1201a and 1201b, with the reference voltage of the voltage reference circuit 1201e. Subsequently, the op-amp 1201f drives the transistor 1200 based on the comparison result. As a result, the DC voltage supplied by the rectifier 112 is regulated to the predetermined DC voltage and is supplied to the drive circuit 121. Similarly, the IGBT drive circuits 13-17 shown in FIG. 1 perform the same operation. Further, as shown in FIG. 3, when the controller 18 outputs the switching command when it is necessary, the MOSFET 1201d is turned on to change the dividing voltage ratio of the voltage divider consisting of 1201a and 1201b when the output voltage of the series regulator 120 is detected. Since the detected voltage is changed so that the output voltage of the series regulator 120 can be changed even with the same reference voltage.

As shown in FIG. 1, the controller 18 is configured to output the drive signal to the IGBT drive circuits 12-17. As shown in FIG. 3, the MOSFETs 121a and 121b are turned on and off in response to the drive signal to control the gate voltage of the IGBT 100 to which the regulated DC voltage from the series regulator 120, is applied. Hence, the IGBT 100 can be turned on and off. Also, the IGBT drive circuits 13-17, as shown in FIG. 1, operate similarly to the above. Specifically, the IGBT 100-105 are controlled to be turned on and off whereby the DC voltage of the battery 10 is converted to the three-phase AC voltage. As a result, the three-phase AC motor generates a driving force by supplying the converted three-phase AC voltage.

According to the embodiment, the control circuit 1201 and the drive circuit 121 are integrated as the one IC 123. Therefore, the number of circuit components can be reduced by this configuration compared to a circuit configuration using discrete devices. In the embodiment, the transistor 1200 is heated due to a large amount of current flowing in the transistor 1200 when it is operated. The transistor 1200 is not integrated in the IC 123. However, the transistor 1200 is disposed as an external component to the IC 123. Hence, the heat produced by the IC 123 can be reduced whereby an IC package having high heat-radiation characteristics is not necessarily used so that the increasing the size of the IC 123 is avoided. As a result, in the power converting circuit 10 which is mounted on a vehicle, the IGBT drive circuits 12-17 for driving IGBTs 100-105 are integrated into the ICs, thereby reducing the circuit components. Also, when the circuit components are integrated to the ICs, the ICs can be prevented from being larger in its dimensions. Furthermore, since the transistor 1200 is configured as an external component, the current capacity i.e., output current of the series regulator can readily be changed by changing the external transistor. Therefore, the IC 123 can be adapted to series regulators that require various current capacities.

What is claimed is:

1. An apparatus for driving a switching device, comprising:
a regulator that generates a regulated voltage at an output terminal, the regulated voltage being generated from an input voltage inputted from an input terminal, the regulator comprising:
a transistor including three terminals of which one terminal is used as a control terminal to control an operation of the transistor and other two terminals are connected to the input terminal and the output terminal of the regulator, and
a control circuit that controls the transistor via the control terminal to maintain the regulated voltage at the output terminal to be an predetermined voltage; and
a drive circuit that is connected to the output terminal of the regulator, and drives the switching device by the voltage supplied via the output terminal,
wherein the control circuit and the drive circuit are integrated into a single integrated circuit, and the transistor is arranged outside the integrated circuit and electrically connected to the integrated circuit.

2. The apparatus according to claim 1, wherein the switching device is adapted to be used in a power converting circuit to convert power by using the switching device being driven by the drive circuit.

3. The apparatus according to claim 1, wherein the power converting circuit is mounted on a vehicle.

4. The apparatus according to claim 2, wherein the power converting circuit is mounted on a vehicle.

5. The apparatus according to claim 1, wherein the control circuit
comprises a voltage divider that divides the regulated voltage at the output terminal, and
the control circuit is configured to maintain the regulated voltage to be the predetermined voltage based on the voltage divided by the voltage divider.

6. The apparatus according to claim 5, wherein
the voltage divider is configured to change a dividing voltage ratio of the voltage divider so that the predetermined voltage is changed to a different value.
